(19) United States
(12) Patent Application Publication
(10) Pub. No.: US 2018/0363744 A1
(43) Pub. Date: Dec. 20, 2018

(54) CHAIN PIN RETENTION

(71) Applicant: BorgWarner Inc., Auburn Hills, MI (US)

(72) Inventors: Douglas S. FORNELL, Ithaca, NY (US); Woo-Serk PARK, Ithaca, NY (US); Timothy K. WHITE, Sterling Heights, MI (US)

(21) Appl. No.: 16/063,342

(22) PCT Filed: Dec. 7, 2016
(86) PCT No.: PCT/US2016/065247

§ 371 Date: Jun. 18, 2018

Related U.S. Application Data
(60) Provisional application No. 62/269,594, filed on Dec. 18, 2015.

(51) Int. Cl. F16H 9/24; F16G 13/06; F16G 5/18

(52) U.S. Cl. CPC F16H 9/24; F16G 5/18; F16G 13/06

(57) ABSTRACT

A chain belt for a continuously variable transmission which has a plurality of links and a plurality of coupling members which connect the plurality of links together. Each of the coupling members has a first end with a first bore and a second end with a second bore. A first retaining pin is fastened within the first bore of each of the coupling members and a second retaining pin is fastened within the second bore of each of the coupling members. The first and second retaining pins retain the plurality of links on the coupling member.

### BACKGROUND OF THE INVENTION

### Field of the Invention

The invention pertains to the field of endless-loop power transmission elements. More particularly, the invention pertains to chain pin retention in a chain belt for a continuously variable transmission (CVT).

### Description of Related Art

Some continuously variable transmissions (CVTs) use a chain belt and two pulleys (usually called “sheaves”) which are connected by the chain belt. Each sheave has two halves with sloping inner faces, and the distance between the halves of the sheaves can be varied. Changing the inner distance of the sheaves varies the effective diameters of the sheaves by causing the load members (struts) on the chain belt which contact the sloping inner surfaces of the sheaves to move radially inward or outward from the axis of rotation. By having the sheaves expand or contract oppositely, the ratio of the transmission (the ratio of the rotational speed of the driving and driven sheaves) is changed by changing the position at which the load members of the chain belt contact the sloping inner surfaces of each of the sheaves.

Chain belts for a continuously variable transmission include lengthwise links with apertures which are connected to each other through pins or struts. Retaining elements, such as a spherical metal ball, metallic bead, hemispherical metallic element, cylindrical metallic element, and square metallic block are welded to the surface ends of the pins or struts and are used to secure the links against falling off of the struts or from becoming misaligned. The welded elements on the surface ends of the struts can easily break during handling of the chain due to variations of the weld.

### SUMMARY OF THE INVENTION

A chain belt for a continuously variable transmission which has a plurality of links and a plurality of coupling members which connect the plurality of links together. Each of the coupling members has a first end with a first bore and a second end with a second bore. A first retaining pin is fastened within the first bore of each of the coupling members and a second retaining pin is fastened within the second bore of each of the coupling members. The first and second retaining pins retain the plurality of links on the coupling member.

### BRIEF DESCRIPTION OF THE DRAWING

FIG. 1 shows a perspective view of a chain belt of an embodiment of the present invention.

FIG. 2 shows a side view of the chain belt of an embodiment of the present invention.

FIG. 3 shows a cross-section along line 3-3 of the chain belt of FIG. 2 of an embodiment of the present invention.

FIG. 4 shows a cross-section along line 3-3 of the chain belt of FIG. 2 with retaining pins and associated bores in the coupling member of an alternate embodiment.

FIG. 5 shows a cross-section along line 3-3 of the chain belt of FIG. 2 with retaining pins and associated bores in the coupling member of another alternate embodiment.

FIG. 6 shows a perspective view of a chain belt of another embodiment of the present invention.

FIG. 7 shows a side view of the chain belt of another embodiment of the present invention.

FIG. 8 shows a cross-section along line 8-8 of the chain belt of FIG. 7 of another embodiment of the present invention.

FIG. 9 shows a top view of a chain belt of another embodiment of the present invention.

### DETAILED DESCRIPTION OF THE INVENTION

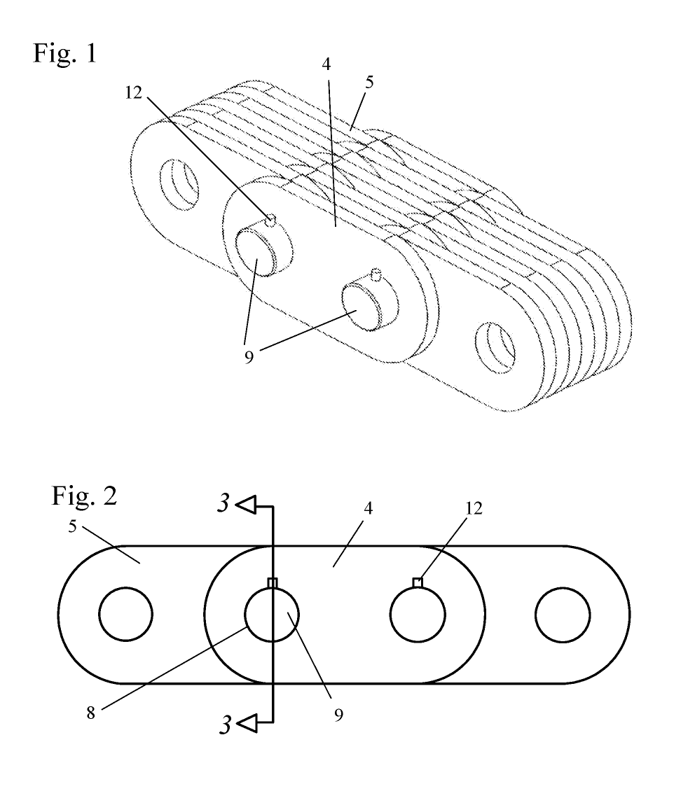

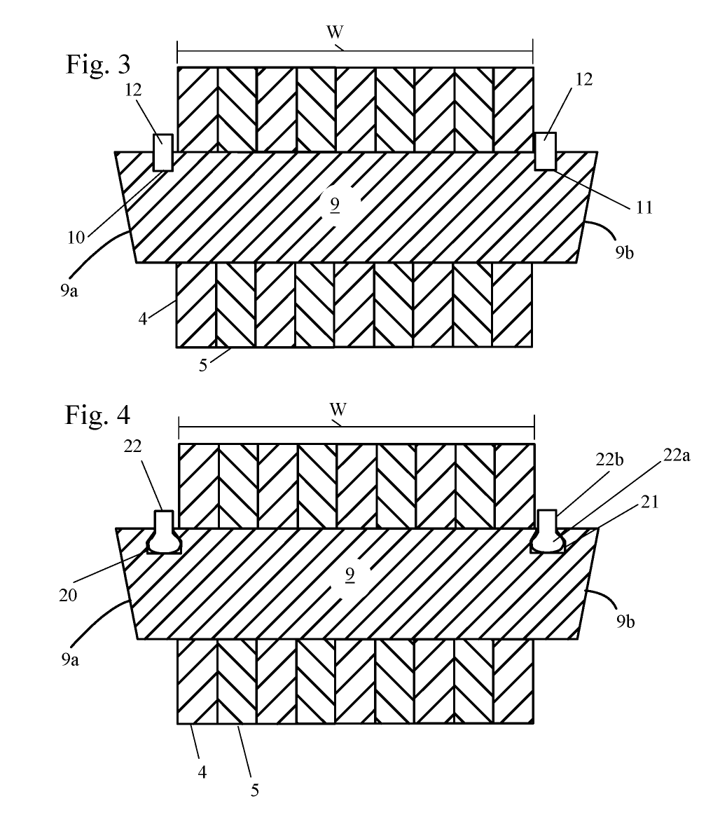

FIGS. 1-5 show a chain belt for a continuously variable transmission. The chain belt 3 has alternating sets of links 4 and 5. Each of the links 4-5 has at least one aperture 8 and preferably has a set of apertures. The sets of links 4-5 are coupled together through a coupling member 9 which serves as a load member or strut for the CVT. It should be noted that the number of links may also vary from the links shown in the Figures within the scope of the invention.

The coupling member 9 has a first end 9a and a second end 9b, with the alternating sets of links 4-5 being threaded on the coupling member 9 between the first end 9a and the second end 9b. The coupling member 9 also includes a first bore 10 at the first end 9a and a second bore 11 at the second end 9b for each receiving a retaining member 12. The retaining member 12 prevents the sets of links 4-5 from falling off of the coupling member 9 and from being misaligned. The position of the bores 10 at the first end 9a and bore 11 at the second end 9b of the coupling member 9 may vary from the position shown in the figures and is dependent upon the width W of the connected sets of links 4-5.

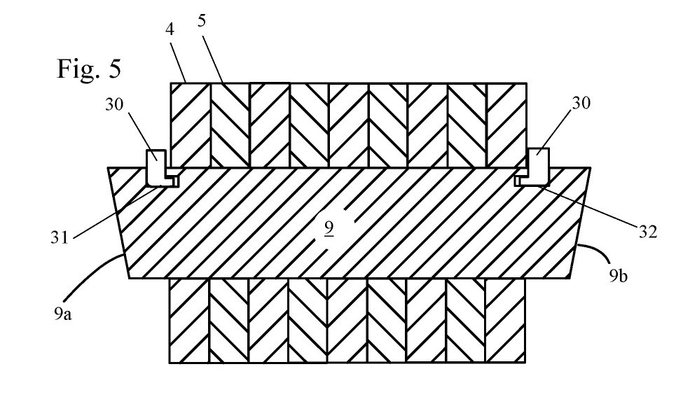

As shown in FIG. 3, each of the bores 10, 11 of the coupling member 9 may receive a retaining member 12, such as a pin. The pin 12 may be welded into the bores 10, 11. Alternatively, the bores 10, 11 may be sized to be slightly smaller or substantially the same size than the pin 12, such that the pin 12 is secure in the bore once inserted (press-fit) without welding.

The pin 12 may be rectangular, square, round or a combination of shapes. The bores 10, 11 may be round, square, rectangular or a combination of shapes. The bores 10, 11 may be blind holes, through holes, staged holes or multiple staged holes.

In an alternate embodiment as shown in FIG. 4, the bores 20, 21 of the coupling member 9 are staged or multiple staged. The pins 22 may be shaped with a head portion 22a and a tail portion 22b and be mushroom shaped. The bores 20, 21 may be shaped to receive the head portion 22a of the pin 22 but not allow the head 22a to be removed from the bore 20, 21, essentially riveting the pin 22 to the bores 20, 21.

In another embodiment, the bores 30, 31 of the coupling member 9 may be an L-shape 31, 32 to allow a pin 30 to be press fit or snug fit and then bent such that a portion 33 of the pin 30 is captured in the L-shaped bore 31, 32 of the coupling member and cannot be removed as shown in FIG. 5.

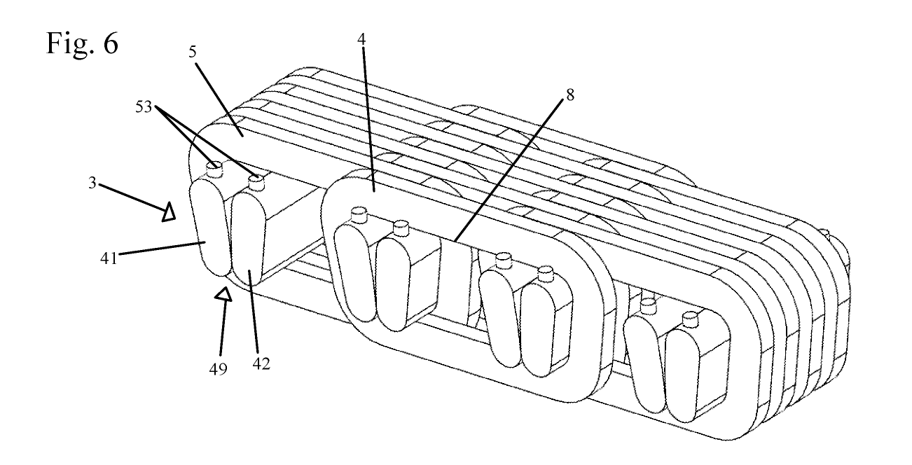

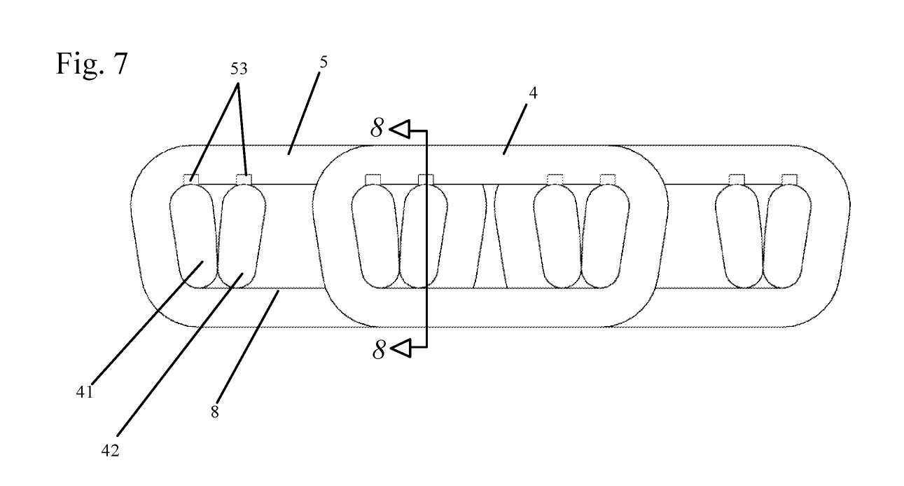

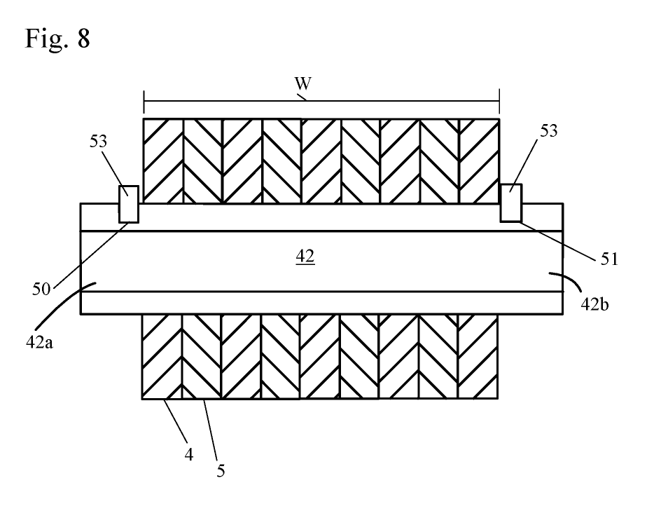

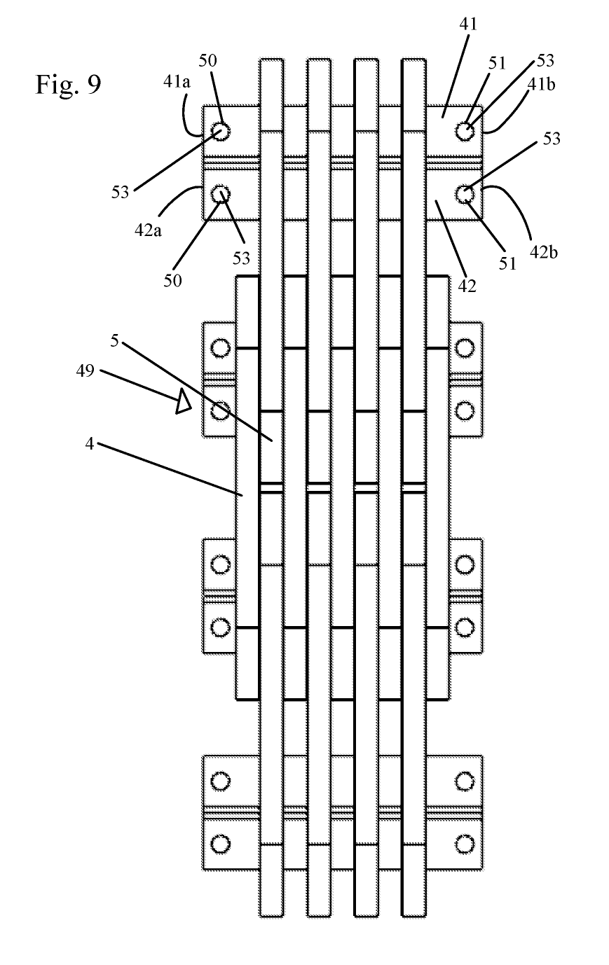

The coupling member 9 may be a single connecting pin as shown in FIGS. 1-5 or may be connecting pins composed of a joint pin and a rocker pin as shown in FIGS. 6-9.

Referring to FIGS. 6-9, a chain belt 3 has alternating sets of links 4 and 5. Each of the links 4-5 has at least one aperture 8. The sets of links 4-5 are coupled together through coupling members 49 which serves as load members or struts for the CVT. The coupling members 49 include a joint pin 41 and a rocker pin 42. The joint pin 41 and rocker pin 42 each have a first end 41a, 42a and a second end 41b, 42b. The alternating set of links 4-5 are threaded onto the coupling members 49 between the first ends 41a, 42a and second ends 41b, 42b of the joint pin 41 and rocker pin 42. The joint pin 41 and rocker pin 42 each include a first bore 50 at the first end 41a, 42a and a second bore 51 at the second end 41b, 42b for receiving a retaining member 53. The retaining member 53 prevents the sets of links 4-5 from falling off of the coupling members 49 and from being misaligned. The position of the bores 50, 51 at the first end 41a, 42a and at the second end 41b, 42b of the coupling member 49 may vary from the position shown in the figures and is dependent upon the width W of the connected sets of links 4-5. Furthermore, the bores 50, 51 may be shaped as shown in FIGS. 3-5. Similarly, the associated retaining member 53 may also be shaped as shown in FIGS. 3-5.

It should be noted that the links and coupling member are shown generically and that any design of the links or types of coupling members may be used within the scope of the invention. It should also be noted that the number of links may also vary from the links shown in the Figures within the scope of the invention.

It should be noted that while in the figures both of the bores at the first end and the second end of the coupling member were shown as being the same, any combination of shaped bores and associated pins disclosed above and in FIGS. 3-5 may be used.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A chain belt for a continuously variable transmission, the chain belt comprising:
a plurality of links;
a plurality of coupling members connecting the plurality of links together, each coupling member having a first end with a first bore and a second end with a second bore;
a first retaining pin fastened within the first bore of each of the coupling members; and
a second retaining pin fastened within the second bore of each of the coupling members.

2. The chain belt of claim 1, wherein the first retaining pin and the second retaining pin are fastened within the first bore and the second bore by welding.

3. The chain belt of claim 1, wherein the first retaining pin and the second retaining pin are fastened within the first bore and the second bore by press fit of the first and second retaining pins in the first and second bores.

4. The chain belt of claim 1, wherein at least one of the first bore and the second bore are L-shaped.

5. The chain belt of claim 4, wherein the first retaining pin and the second retaining pin are fastened within the first bore and the second bore by bending the first retaining pin and the second retaining pin after the first and second retaining pins are inserted into the first and second bores.

6. The chain belt of claim 1, wherein at least one of the first bore and the second bore is a through hole.

7. The chain belt of claim 1, wherein at least one of the first bore and the second bore are staged holes.

8. The chain belt of claim 1, wherein the coupling members comprise at least one rocker pin.

9. The chain belt of claim 1, wherein the coupling members comprise a pin.

10. The chain belt of claim 1, wherein at least one of the first bore and the second bore are blind holes.

11. The chain belt of claim 1, wherein at least one of the first bore and the second bore are multi-staged holes.
